(19) United States
(12) Patent Application Publication
(10) Pub. No.: US 2004/0015539 A1
(43) Pub. Date: Jan. 22, 2004

(54) Content exporting from one application to another

(76) Inventors: Andrew Alegria, Nampa, ID (US); Brett Smith, Boise, ID (US); Larry Reitz, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/198,336

(22) Filed: Jul. 16, 2002

(51) Int. Cl. G06F 15/16

(52) U.S. Cl. 709/203

(57) ABSTRACT

Systems and methods for exporting content are described herein. In one embodiment, the systems and methods pertain to presenting at least one export destination to a user for selection, receiving a user destination selection, and automatically inserting selected content into the destination selection.

### FIELD OF THE INVENTION

The present disclosure relates to exporting content from one application to another. More particularly, the disclosure relates to systems and methods with which content such as text and images can, at least partially, be automatically exported from one user application to another user application.

### BACKGROUND OF THE INVENTION

Often, computing device users wish to export content from one user application to another. For instance, where such a user is developing a report at work about a given research topic, the user may conduct research on-line and discover text and/or images that the user would like to export to a user application, such as a word processing application, to develop a written report on the research findings. To cite another example, another user may wish to simply export content from a document of a first user application, e.g., an image from an imaging application, to another document of a second application, e.g., a spread sheet application.

To export content such as in the above-described examples, the user normally is called upon to first select the given content, for instance by highlighting the content using a mouse, and copy the content by, for instance right-clicking on the selected content and selecting a “copy” command from a pop-up box that appears. Alternatively, the content can be copied by, for example, simultaneously selecting the “ctrl” key and the “C” key of the user's keyboard. Next, if the destination application is not already running, the user must open the destination application by, for example, double-clicking on an icon provided on the user's desktop or selecting the application from a listing of available applications in a start-up menu. To do this, the user may need to exit the source application by, for instance, closing the application or minimizing it.

Once the destination application has been opened, or if it was already open, the user must either create a new document in the destination application or select an existing document from the application, as the case may be. In the former situation, the user will need to either select an icon from a tool bar of the destination application or select a new document command from a menu of the destination application. In the latter situation, the user will need to either access an already open document, or open the desired document if not currently open. If the desired document is already open, the user will need to select the document by, for instance, selecting an appropriate icon presented in the user desktop interface. Notably, time may be required to determine which icon represents the desired document where several documents and/or applications are currently open.

If the desired document is not already open, the user will need to first select an appropriate icon of the destination application tool bar or select an open document command from another menu of the destination application. Next, the user must browse through a listing of various documents stored in the format of the destination application and then select the desired document by, for example, highlighting it and selecting an “open” button.

After a new document or the existing document has been opened, or after accessing an already open document, the user can insert the selected content by, for example, right-clicking within the document and selecting a “paste” command. Alternatively, the user can use an appropriate short-cut key sequence (e.g., simultaneous selection of the “ctrl” key and the “V” key of the user's keyboard). At this point, the user can arrange the content within the destination application document as desired.

As can be appreciated from the process described above, the exportation of content from one user application to another is labor-intensive. Specifically, the process typically involves a multiplicity of key or mouse strokes, manual switching between multiple applications, manual opening of files, etc. Although the process is not difficult per se, it can be tedious. Therefore, it can be appreciated that it would be desirable to have systems and methods with which this process is at least partially automated for the user to reduce the amount of work required of the user to accomplish successful exportation of content.

### SUMMARY OF THE INVENTION

The present disclosure relates to exporting content. Systems and methods for exporting content are described herein. In one embodiment, the systems and methods pertain to presenting at least one export destination to a user for selection, receiving a user destination selection, and automatically inserting selected content into the destination selection.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a block diagram that illustrates exporting of content from one or more content sources to a content destination.

FIG. 2 is a schematic diagram of computing system that can be used to export content from one application to another in the manner illustrated in FIG. 1.

FIG. 3 is a flow diagram of a first example method for content exportation.

FIGS. 4A and 4B provide a flow diagram of operation of an export utility in facilitating content exportation.

FIG. 5A is a schematic view of a source application during part of an example content exporting process.

FIG. 5B is a schematic view of the source application of FIG. 5A during another part of an example content exporting process.

### DETAILED DESCRIPTION

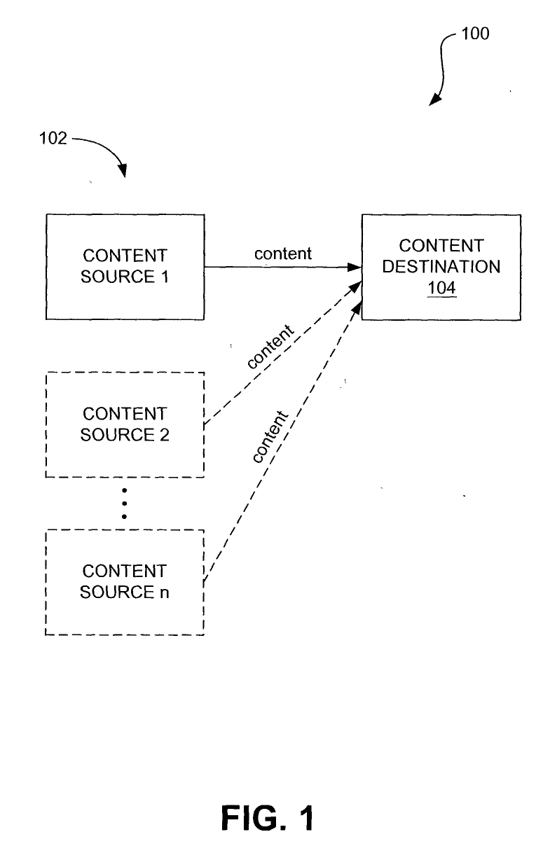

Referring now in more detail to the drawings, in which like numerals indicate corresponding parts throughout the several views, FIG. 1 illustrates a generalized system 100 for exporting content. As indicated in this figure, the system 100 generally comprises one or more content sources 102 (i.e., content sources 1 through n) and a content destination 104. The content sources 102 and content destination 104 typically comprise user applications which can be stored within one or more appropriate computing systems, for example, a personal computer (PC), a personal digital assistant (PDA), etc. The user applications can comprise substantially any user application including word processing applications, spread sheet applications, drawing applications, imaging applications, browser applications, presentation applications, scheduling applications, etc. The content can comprise any content that can be supported by the content sources 102 and the content destination 104. For instance, the content can comprise text, drawings, images, and the like.

As indicated in FIG. 1, the content can be supplied to the content destination 104 from the content sources 102. In some situations, this may entail the provision of content from multiple sources to a single content destination 104. Although not indicated in FIG. 1, it is to be understood that content can also be provided from the content source(s) 102 to multiple different content destinations, if desired. As is discussed in greater detail below, the exportation (i.e., sharing) of content is, at least in part, automated for the user so as to reduce the tedium normally involved with exporting content from one application to another.

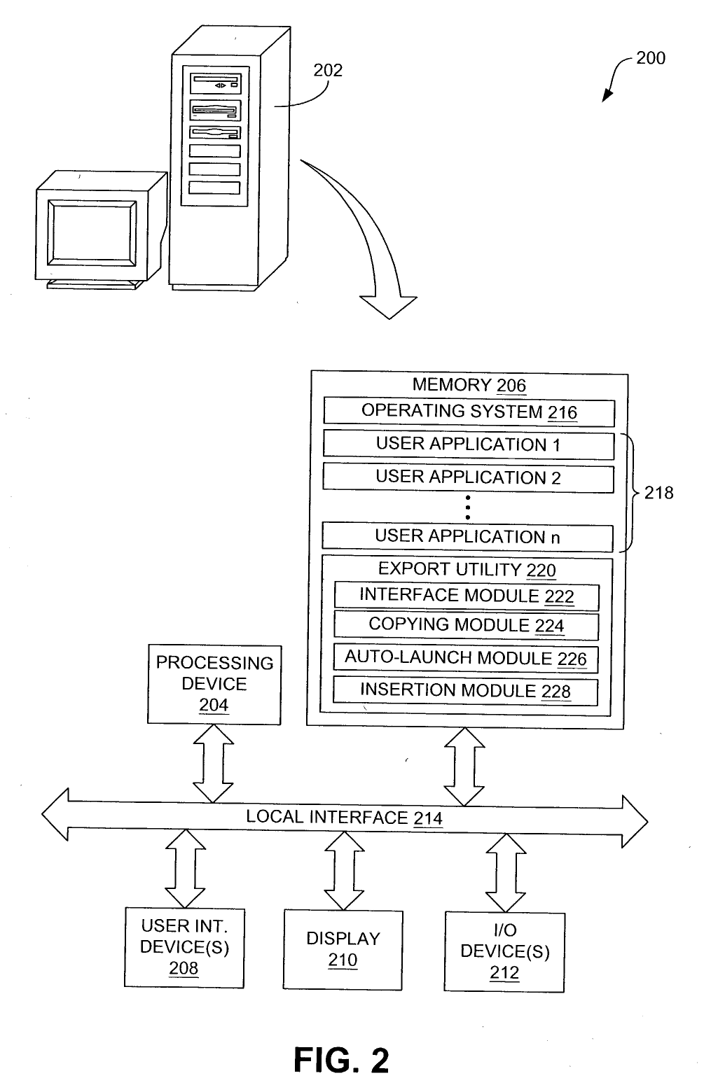

FIG. 2 is a block diagram of an example architecture for a computing system 200 that can facilitate sharing of content between user applications. As is apparent from FIG. 2, the computing system 200 is represented as a computing device, namely a desktop PC 202. Although such a computing device is depicted in the figure and described herein, it is to be appreciated that the computing device is illustrated and described by way of example only for purposes of discussion. Therefore, persons having ordinary skill in the art will appreciate that alternative computing systems may be used, if desired.

As indicated in FIG. 2, the computing system 200 can, for instance, comprise a processing device 204, memory 206, one or more user interface devices 208, a display 210, and one or input/output (I/O) devices 212, each of which is connected to a local interface 214 that can comprise one or more internal and/or external buses. The processing device 204 can include any custom made or commercially available processor, a central processing unit (CPU) or an auxiliary processor among several processors associated with the computing system 200, a semiconductor based microprocessor (in the form of a microchip), or a macroprocessor. The memory 206 can include any one of a combination of volatile memory elements (e.g., RAM, such as DRAM, SRAM, etc.) and nonvolatile memory elements (e.g., ROM, hard disk, tape, CDROM, etc.).

The one or more user interface devices 208 comprise those components with which the user can interact with the computing system 200. By way of example, these components can comprise a keyboard and mouse, one or more buttons or function keys, a display, a stylus, etc. The display 210 may comprise, for instance, a computer monitor or a touch-sensitive liquid crystal display (LCD).

The one or more I/O devices 212 comprise components used to facilitate connection of the computing system 200 to other systems. These I/O devices 212 can, for instance, comprise one or more serial, parallel, small system interface (SCSI), universal serial bus (USB), IEEE 1394 (e.g., Firewire™), or personal area network (PAN) connection devices.

With further reference to FIG. 2, the memory 206 comprises an operating system 216, one or more user applications 218 (i.e., applications 1 through n), and an export utility 220. The operating system 216 comprises the software and/or firmware that controls the general operation of the computing system 200. The user applications 218 comprise one or more programs that may serve as a content source and/or a content destination. As indicated above with reference to FIG. 1, these applications may comprise word processing applications, spread sheet applications, drawing applications, imaging applications, browser applications, presentation applications, scheduling applications, etc. Examples of commonly available user applications include, for example, Word™, Excel™, Corel Draw™, Visio™, Acroba™, Internet Explorer™, Navigator™, Outlook™, Paint™, PhotoShop™, Power Point™, Quicken™, and so forth.

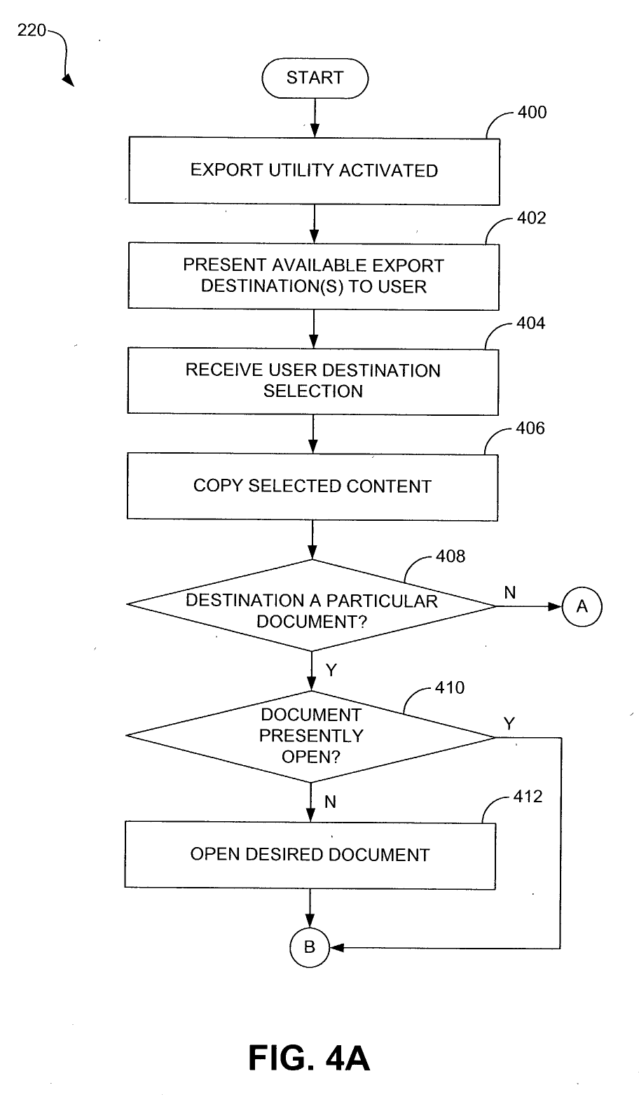

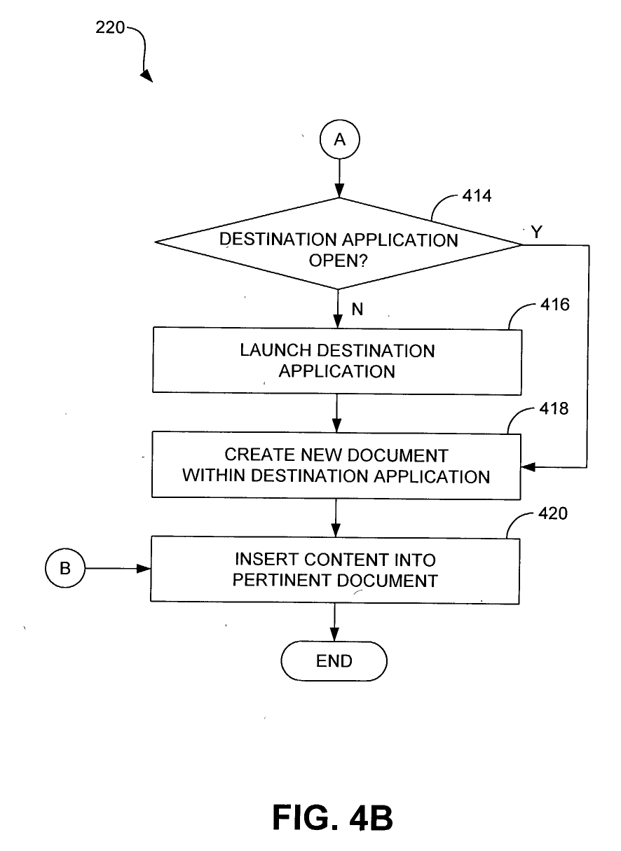

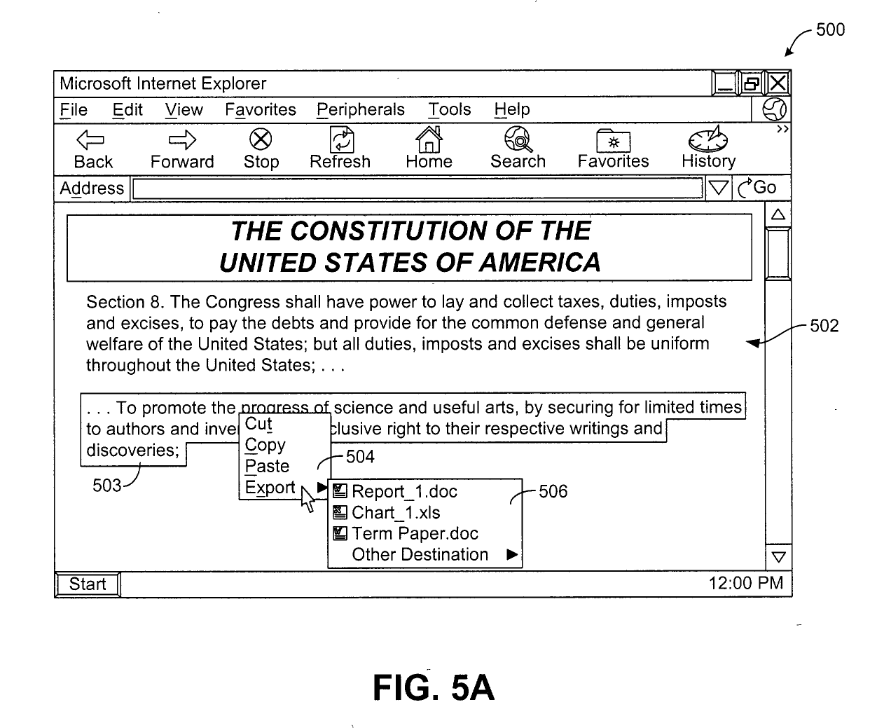

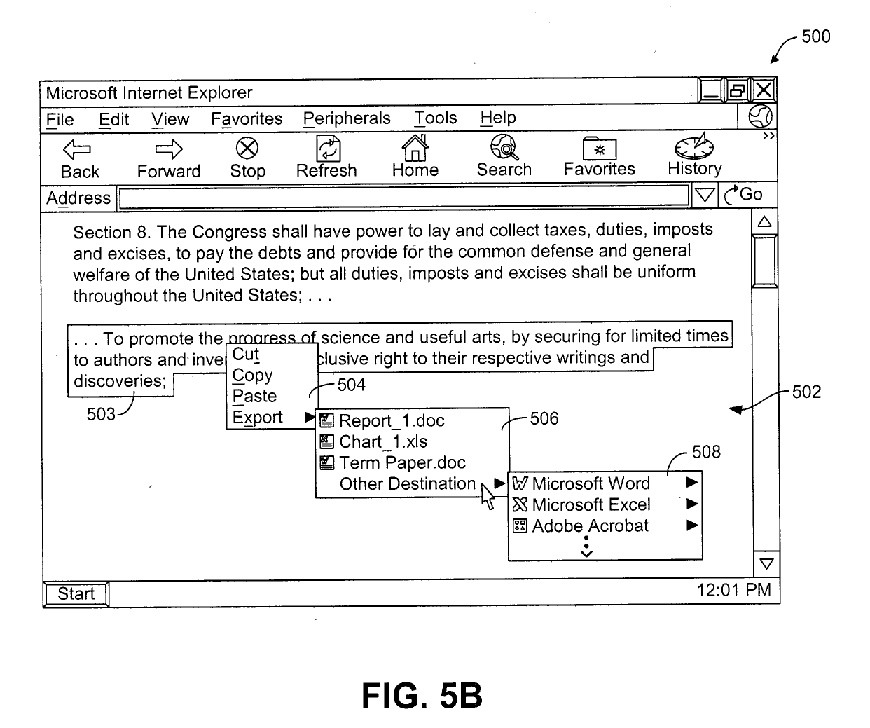

The export utility 220 comprises the code, i.e. software and/or firmware, that is used to, at least partially, automate the exporting of content from content sources to content destinations and, more particularly, the exportation of content from a source application to a destination application. The export utility 220 can comprise, for instance, an interface module 222 that supports one or more user interfaces with which the user can enter selections and/or commands, a copying module 224 that is used to copy selected content, an auto-launch module 226 that is used to automatically launch selected destination documents and/or applications, and an insertion module 228 that is used to insert the selected content into the destination file and/or application. Operation of the export utility 220 is described in more detail with reference to FIGS. 4-5 below.

Various code (software and/or firmware) has been described herein. It is to be understood that this code can be stored on any computer-readable-medium for use by or in connection with any computer-related system or method. In the context of this document, a computer-readable medium is an electronic, magnetic, optical, or other physical device or means that can contain or store a computer program for use by or in connection with a computer-related system or method. The code can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. A “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, RAM, ROM, an erasable programmable read-only memory (EPROM, EEPROM, or flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

As identified above, exporting content from one user application to another user application can be tedious for the user. Using the systems and methods described herein, however, the process can be, at least partially automated, so as to reduce the amount of work required of the user to share such content. In the discussion that follows, example of content exporting process are described and flow diagrams are provided. It is to be understood that any process steps or blocks in these flow diagrams may represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

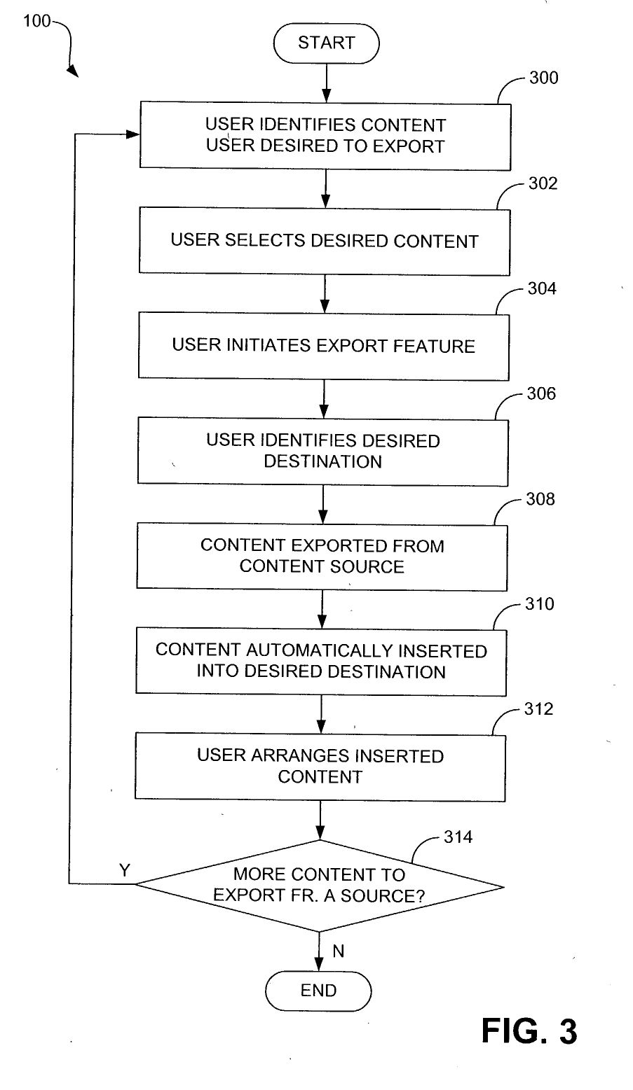

FIG. 3 provides an overview of one example method for exporting content. More specifically, FIG. 3 illustrates an example method for exporting content from a source application to a destination application. Beginning with block 300, the user first identifies content that the user desires to export. This content is identified in a first application that can, as identified above, comprise, for example, a word processing application, spread sheet application, drawing application, imaging application, browser application, presentation application, scheduling application, or the like. The content can comprise substantially any content that can be copied from one application and inserted into another. By way of example, the content can comprise text, drawings, icons, images, etc.

Once the user has identified the content he or she would like to export, the user selects the desired content, as indicated in block 302. The content can be selected in various ways. Typically, the content is selected using a mouse or an equivalent user interface device. In such a case, the user can, for instance, highlight the desired content by left-clicking with the mouse, passing an on-screen cursor over the desired content, and releasing the mouse button. In an alternative method, the user may use various keystrokes to select the desired content (e.g., using the “Tab” key).

Irrespective of the manner in which the content is selected, the user can then initiate the export feature, as indicated in block 304. As will be appreciated by persons having ordinary skill in the art, the user may initiate the export feature in several different ways. In one example, the user can right-click on the selected content to cause a pop-up box to appear and select an “export” command presented in the box. In another example, the user can enter various key strokes to cause the pop-up box to appear (e.g., by depressing “ctrl” and another key simultaneously), and select the export command. In a further example, the user can select an “export” button that is provided in an appropriate toolbar of the application that includes the content to be exported (i.e., the source application), to cause a drop-down menu to appear. As can be appreciated by these examples, some form of user interface normally is provided to the user when the export feature is initiated, regardless of the method used to initiate it.

Once the export feature has been initiated, the user can identify the desired destination for the content, as indicated in block 306. Normally, this destination is identified through use of the user interface that is presented to the user once the export feature is initiated. The destination typically comprises another application separate from the source application. Again, by way of example, the other application may comprise a word processing application, spread sheet application, drawing application, imaging application, browser application, presentation application, scheduling application, or the like. As is discussed in greater detail below, the user interface presented to the user facilitates the identification of the desired destination to reduce the amount of work required of the user during the export process.

After the user has identified the desired destination, the selected content is exported from the source application, as indicated in block 308, and then is automatically inserted into the desired destination (i.e., destination application), as indicated in block 310. As is discussed below, this step may involve one or more of automatically launching the destination application, creating a new document within the destination application, opening an existing document of the destination application, and pasting, the content into a desired document of the destination application.

Once the content has been inserted into the destination application, the user can arrange the content into a desired format, as indicated in block 312. Next, with reference to decision element 314, it can be determined whether more content is to be exported from a source application to a destination application. If so, flow returns to block 300 described above. If not, flow for the exporting session is terminated.

FIGS. 4A and 4B illustrate an example of operation of the export utility 220 shown in FIG. 2 during an exportation process. It is noted that, although specific steps are described in FIGS. 4A and 4B, and specific interfaces shown in FIGS. 5A and 5B, these steps and interfaces are merely illustrative of one embodiment of the exporting process. Persons having ordinary skill in the art will appreciate that many variations on the themes described below are possible.

Beginning with block 400 of FIG. 4A, the export utility 220 is first activated. As described above with reference to FIG. 3, this activation may occur in response to the user right-clicking on selected content to cause a pop-up box to appear and selecting an “export” command contained within the pop-up box, entering various key strokes to cause a pop-up box to appear and selecting the export command, or directly selecting an “export” button that is provided in an appropriate toolbar of the source application. An example of the first method is illustrated in FIG. 5A which depicts a browser application (i.e., Microsoft Internet Explorer™) as the source application. As indicated in this figure, the browser application comprises an application interface 500 that includes a window 502 in which various content (in FIG. 5A) text is presented. In this example, the user has selected (by highlighting) a portion 503 of text that is to be exported into a destination application. In addition, the user has caused a first popup box 504 to appear, for example by right-clicking on the selected text. Furthermore, the user has activated the export utility 220 by selecting the “Export” command from the first pop-up box 504. As indicated in the figure, this command can have been selected by simply “mousing-over” (i.e., positioning the cursor without depressing a mouse button) the “Export” command.

With reference back to FIG. 4A, the export utility 220 next presents one or more available export destinations to the user, as indicated in block 402. By way of example, and with reference back to FIG. 5A, these destinations can be presented to the user for selection with a second pop-up box 506 that appears when the “Export” command is selected. This pop-up box 506, and the others described below, are generated by the interface module 222 of the export utility 220. As shown in FIG. 5A, the destinations can comprise one or more particular documents and/or files, in this example, “Report_{—}1.doc”, “Chart_{—}1.xls”, and “Term Paper.doc”. Where particular documents are presented to the user as selectable destinations, the documents can comprise documents to which content previously has been exported (e.g., in the same work session), documents that have most recently been accessed and/or modified in some manner, documents contained in a particular folder or subdirectory of the user's hard disk, etc.

As is further illustrated in FIG. 5A, the user can also be presented with an “Other Destination” option which, when selected (e.g., by mouse-over), presents various destination applications to the user for selection. An example of this is illustrated in FIG. 5B in which, through selection of the “Other Destination” option, a third pop-up box 508 has been presented to the user which includes a variety of different destination applications (e.g., Microsoft Word™, Microsoft Excel™, Adobe Acrobat™) that can be chosen. As is indicated by the arrowheads adjacent the various destination applications listed in the third pop-up box 508, further pop-up boxes (or other user interfaces) may be accessed by selecting (e.g., by mouse-over) a given application. This feature may be used to, for instance, select another specific documents and/or files by browsing a hard disk of the user's computing system. This way, a particular desired destination document can be selected even if it is not initially presented to the user for selection in the initial user interface (e.g., first pop-up box 504). Notably, where a desired document does not already exist, the user can simply select a desired destination application, for example by clicking on the application in the third pop-up box 506. In such a case, as described below, a new document will automatically be created by the export utility 220 for the user in the selected application.

Returning to FIG. 4A, the export utility 220 can receive the user destination selection, as indicated in block 404, that was input by, for instance, clicking on a desired document or application. At this point, the selected content is copied (if it was not already copied earlier), as indicated in block 406, by the copying module 224 of the export utility 220. Next, it can be determined whether the user selected a particular existing document, as indicated in decision element 408. If not, flow continues down to decision element 414 of FIG. 4B, which is described below. If, on the other hand, the user did select a particular document, flow continues to block 410 at which it is determined whether the document is presently open. If so, flow continues to block 420 of FIG. 4B, which is described below. If not, however, flow continues to block 412 at which the export utility 220 opens the desired document, for instance using the auto-launch module 226.

Continuing to block 414 of FIG. 4B, it can be determined whether a destination application that the user has selected is currently open. If so, flow continues down to block 418 described below. If the destination application is not open, however, the export utility 220 automatically launches the destination application, as indicated in block 416, again using the auto-launch module 226. This automatic launching of the destination application removes the tedium normally involved in locating and manually opening the application. Once the destination application has been launched, or if it was already open (decision element 414), the export utility 220 creates a new document within the destination application as indicated in block 418. This step further relieves the user of having to manually create the new document.

Next, with reference to block 420, the selected (i.e., copied) content can be inserted into the pertinent document of the destination application, for instance by the insertion module 228. Accordingly, whether the user selected an existing document or a desired application generally, the content from the source application is inserted, i.e., pasted, into a document of the destination application.

With the mode of operation described above with reference to FIG. 3 and FIGS. 4A and 4B, the content exporting process can be substantially automated for the user to reduce the amount of work required of the user to import content into a desired destination application and/or document. Therefore, exportation can be accomplished both more quickly and efficiently with less user frustration.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for sharing content, comprising:
presenting at least one export destination to a user for selection;
receiving a user destination selection; and
automatically inserting selected content into the destination selection.

2. The method of claim 1, wherein the step of presenting comprises presenting a user interface to the user that comprises a list of at least one export destination.

3. The method of claim 2, wherein the step of presenting comprises presenting a user interface to the user that comprises a list of at least one destination application.

4. The method of claim 2, wherein the step of presenting comprises presenting a user interface to the user that comprises a list of at least one destination document.

5. The method of claim 1, wherein the step of receiving comprises receiving selection of a destination presented to the user in a list of possible destinations.

6. The method of claim 1, wherein the step of automatically inserting comprises automatically accessing an open document and pasting the content into the document.

7. The method of claim 1, wherein the step of automatically inserting comprises automatically opening an existing document and pasting the content into the document.

8. The method of claim 1, wherein the step of automatically inserting comprises automatically launching a destination application.

9. The method of claim 8, wherein the step of automatically inserting further comprises automatically creating a new document in the destination application and pasting the content into the new document.

10. The method of claim 1, further comprising copying content selected by the user.

11. A method for exporting content from one user application to another user application, comprising:
copying user selected content;
prompting the user to select a destination document in which to paste the copied content with a user interface that appears after the user right-clicks on the selected content;
receiving a user destination document selection;
automatically accessing the destination document; and
automatically pasting the copied content into the destination document.

12. The method of claim 11, wherein the step of prompting comprises prompting the user to select a destination document from a list that appears after the user right-clicks on the selected content and then selects an export command.

13. A method for exporting content from one user application to another user application, comprising:
copying user selected content;
prompting the user to select a destination application in which to paste the copied content with a user interface that appears after the user right-clicks on the selected content;
receiving a user destination application selection;
automatically launching the destination application;
automatically creating a new document within the destination application; and
pasting copied content into the new document.

14. The method of claim 13, wherein the step of prompting comprises prompting the user to select a destination application from a list that appears after the user right-clicks on the selected content and then selects an export command.

15. A system for facilitating the sharing of content, comprising:
means for presenting at least one export destination to a user for selection;
means for receiving a user destination selection; and
means for automatically inserting selected content into the destination selection.

16. The system of claim 15, wherein the means for presenting comprise means for presenting a user interface to the user that comprises a list of at least one export destination.

17. The system of claim 15, wherein the means for automatically inserting comprise means for automatically accessing an open document and pasting the content in the document.

18. The system of claim 15, wherein the means for automatically inserting comprise means for automatically opening an existing document and pasting the content in the document.

19. The system of claim 15, wherein the means for automatically inserting comprise means for automatically launching a destination application.

20. A system stored on a computer-readable medium for facilitating the sharing of content, comprising:
logic configured to present at least one export destination to a user for selection;
logic configured to receive a user destination selection; and
logic configured to automatically insert selected content into the destination selection.

21. The system of claim 20, wherein the logic configured to present comprises logic configured to present a user interface to the user that comprises a list of at least one export destination.

22. The system of claim 20, wherein the logic configured to automatically insert comprises logic configured to automatically access an open document and paste the content in the document.

23. The system of claim 20, wherein the logic configured to automatically insert comprises logic configured to automatically open an existing document and paste the content in the document.

24. The system of claim 20, wherein the logic configured to automatically insert comprises logic configured to automatically launch a destination application.

25. An exporting program for exporting content from one application to another, comprising:
an interface module configured to generate at least one user interface with which a user can select, while in a first application, a destination for selected content;
a copying module configured to copy the selected content;
an auto-launch module configured to automatically launch at least one of a destination document and a destination application; and
an insertion module configured to insert the copied content into the selected destination.

26. The program of claim 25, wherein the interface module is configured to present at least one pop-up box in response to selection of an export command presented in a pop-up box presented after a user right-clicks the selected content.

27. The program of claim 26, wherein the auto-launch module is further configured to create a new document in the destination application.

28. A computing system, comprising:
a processing device; and
memory including an interface module configured to generate at least one user interface with which a user can select, while in a first application, a destination for selected content, a copying module configured to copy the selected content, an auto-launch module configured to automatically launch at least one of a destination document and a destination application, and an insertion module configured to insert the copied content into the selected destination.
